(19) United States
(12) Patent Application Publication
(10) Pub. No.: US 2014/0269147 A1
(43) Pub. Date: Sep. 18, 2014

(54) BONE CEMENT MIXING AND DELIVERY SYSTEM WITH REDUCED FUME EXPOSURE

(71) Applicant: KYPHON SARL, Neuchatel (CH)

(72) Inventors: Bryan A. CLICK, Fremont, CA (US); Neil S. SASAKI, Santa Clara, CA (US); Craig E. LAUCHNER, Mountain View, CA (US); Tara N. HOLZ, Santa Cruz, CA (US)

(73) Assignee: KYPHON SARL, Neuchatel (CH)

(21) Appl. No.: 13/840,477

(22) Filed: Mar. 15, 2013

(51) Int. Cl. B29B 7/22; B29B 7/12

(52) U.S. Cl. CPC B29B 7/22; B29B 7/12
USPC 366/76.7; 366/96; 366/98

(57) ABSTRACT

A device for mixing and containing fumes for a bone cement component including a base. The base includes an inner wall defines a chamber having a first sealable opening and a passageway. A handle extends between a proximal end and a distal end and includes a seal at the distal end. A plunger housing is configured for moveable disposal of the handle and includes a second sealable opening. The plunger housing is configured to contain a vial therein. The plunger housing is configured for engagement with the base. The plunger housing is configured to move within the passageway. A collapsible paddle attached to the handle between the proximal and distal end and configured to mix the bone cement.

### TECHNICAL FIELD

The present disclosure generally relates to medical devices for bone repair, and more particularly to a component injection and mixing system and method for containing fumes within a device during bone cement preparation.

### BACKGROUND

Many medical procedures employ medical grade cement in connection with the restoration and strengthening of bone structures. During such procedures, cement is typically dispensed to a bone to fill in voids or spaces in the bone or between medical devices or implants attached to or embedded within the bone. These dispensing devices may include systems as simple as syringes and as complex as electronically controlled valves.

Mixing bone cement, such as, e.g., High-Viscosity Radiopaque (HV-R) bone cement, requires integration of two materials, a monomer solution, for example, a liquid that is packaged in a glass vial and a powder. One difficulty with the cement monomer is that it generates toxic fumes that ideally need to be contained to prevent inhalation exposure by medical staff. Current cement mixing techniques involve breaking the monomer vial and pouring the fluid into the powder by hand, then sealing a mixing chamber. This results in ambient exposure to fumes from the monomer component. This disclosure describes improvements over these prior art technologies.

Accordingly, a device for mixing bone cement and preventing the escape of toxic fumes. In one embodiment, in accordance with the principles of the present disclosure, a device for mixing and containing fumes for a bone cement is provided. The device includes a base having an inner wall defines a chamber having a first sealable opening and a passageway. A handle extends between a proximal end and a distal end and includes a seal at the distal end. A plunger housing is configured for moveable disposal of the handle and includes a second sealable opening. The plunger housing is configured to contain a vial therein. The plunger housing is configured for engagement with the base. The plunger housing is configured to move within the passageway. A collapsible paddle is attached to the handle between the proximal and distal end and is configured to mix the bone cement. The handle is moveable between a first orientation such that the handle is disposed within and seals the opening of the plunger housing and a second orientation such that the handle is disposed within and seals the opening of the base.

In one embodiment, in accordance with the principles of the present disclosure, a system for mixing and containing fumes for a bone cement component is provided. The system includes a having an inner wall defines a chamber having a first sealable opening and a passageway. A handle extends between a proximal end and a distal end and includes a seal at the distal end. A plunger housing is configured for moveable disposal of the handle and includes a second sealable opening. The plunger housing is configured to contain a vial therein. The plunger housing is configured for engagement with the base. The plunger housing is configured to move within the passageway. A collapsible whisk attached to the handle between the proximal and distal end and configured to mix the bone cement. A dispensing device is removeably attached to and in communication with the sealable opening of the base. The handle is moveable between a first orientation such that the handle is disposed within and seals the opening of the plunger housing and a second orientation such that the handle is disposed within and seals the opening of the base.

In one embodiment, in accordance with the principles of the present disclosure, a method for containing fumes of a bone cement component is provided. The method includes providing a system for mixing and dispensing bone cement including a base having an inner wall defines a chamber having a first sealable opening and a passageway. A handle extends between a proximal end and a distal end and includes a seal at the distal end. A plunger housing is configured for moveable disposal of the handle and includes a second sealable opening. The plunger housing is configured to contain a vial therein. The plunger housing is configured for engagement with the base. The plunger housing is configured to move within the passageway. A collapsible whisk attached to the handle between the proximal and distal end and configured to mix the bone cement. A dispensing device is removeably attached to and in communication with the sealable opening of the base. The handle is moveable between a first orientation such that the handle is disposed within and seals the opening of the plunger housing and a second orientation such that the handle is disposed within and seals the opening of the base. A vial of a monomer component of bone cement is present in the plunger housing and a powder component of bone cement is present in the base. The seal is positioned at the sealable opening of the plunger housing. The handle is translated through the base such that the seal seals the sealable opening in the base and the whisk expands. The plunger housing is rotated to break the vial. The handle is rotated such that the whisk mixes the bone cement. The handle is moved back into the plunger housing. The dispensing device is attached to the base and the plunger housing is translated through the passageway into the base to dispense the bone cement into the dispensing device.

### BRIEF DESCRIPTION OF THE DRAWINGS

The present disclosure will become more readily apparent from the specific description accompanied by the following drawings, in which:

FIG. 1 is a cross-sectional view showing a system for mixing and containing fumes of bone cement in accordance with the principles of the present disclosure;

FIG. 2 is a cross-sectional view of components of the system shown in FIG. 1;

FIG. 3 is a cross-sectional view of components of the system shown in FIG. 1;

FIG. 4 is a cross-sectional view of components of the system shown in FIG. 1; and

FIG. 5 is a cross-sectional view showing a system for mixing and containing fumes of bone cement in accordance with the principles of the present disclosure.

Like reference numerals indicate similar parts throughout the figures.

### DETAILED DESCRIPTION

The exemplary embodiments of an injection system for mixing bone cement and related methods of use are disclosed in terms of medical devices for the treatment skeletal disorders and more particularly, in terms of a medical system and method for mixing bone cement while limiting exposure to fumes. It is envisioned that the medical system and method may be employed in applications such as bone treatment and repair surgeries. For example, the medical system and method can include new mixing chamber configurations.

In particularly useful embodiments, injection and mixing devices are provided that allow for breaking a monomer vial in an enclosed space to prevent fume exposure, and allowing the monomer to drip into a sealed mixing chamber passing elastomeric seal into a holder chamber having the powdered cement to mix with the monomer. In one embodiment, a collapsible mixing paddle is provided that is configured to retract and be removed from the mixing chamber. The mixing device is completely sealed with the powder and monomer vial prepackaged in the system.

In one embodiment, the system includes of a base containing powder, a plunger housing containing the vial, and a blade. A collapsible paddle is attached to a handle inserted through the plunger housing. The paddle contains a seal at the tip that interfaces with the plunger housing. The practitioner pushes the paddle downwards into the chamber, it expands, and the pathway between the base and plunger housing is opened. The plunger housing is twisted and the vial is broken. The monomer drains into the mixing chamber and the practitioner mixes by twisting the paddle assembly. The handle is retracted, the paddles collapse, cement is wiped from the paddles, and chamber is sealed. The plunger is then advanced to deliver cement.

In one embodiment, the system includes a base containing powder, a plunger assembly containing the vial, a collapsible paddle attached to the plunger, and a cap that is threaded onto the plunger assembly. The practitioner twists the cap to force the vial to pierce on a spike contained within the assembly. The monomer drains into the chamber through a filter. The practitioner pushes on the cap to achieve a rotational mix. With every push a ‘bic pen’ style mechanism indexes the plunger rotationally, with the collapsible paddle providing the return force. This creates a rotational, paddle style mix. To dispense, the plunger is driven forward, collapsing the paddle.

The present embodiments may be employed in conjunction with known cement mixers (e.g., Kyphon™ cement mixers) to introduce monomer into powder in a controlled fashion. Hospitals, in particular European hospitals, are becoming increasingly sensitive to fume exposure during mixing of cements. Use of the monomer introduction devices in accordance with the present principles reduce or prevent fume exposure.

It is contemplated that one or all of the components of the medical system may be disposable, peel-pack, or pre-packed sterile devices. One or all of the components of the medical system may be reusable. The surgical system may be configured as a kit with multiple sized and configured components.

It is envisioned that the present disclosure may be employed to treat or repair bone injuries or disorders such as, for example, osteoporosis, joint replacement, fracture repairs, bone breaks, etc. It is contemplated that the present disclosure may be employed with other osteal and bone related applications, including those associated with diagnostics and therapeutics. It is further contemplated that the disclosed medical systems and methods may be alternatively employed in a surgical treatment with a patient in a prone or supine position, and/or employ various surgical approaches, including anterior, posterior, posterior mid-line, direct lateral, postero-lateral, antero-lateral approaches, etc. in any body region. The system and methods of the present disclosure may also be used on animals, bone models and other non-living substrates, such as, for example, in training, testing and demonstration.

The present disclosure may be understood more readily by reference to the following detailed description of the disclosure taken in connection with the accompanying drawing figures, which form a part of this disclosure. It is to be understood that this disclosure is not limited to the specific devices, methods, conditions or parameters described and/or shown herein, and that the terminology used herein is for the purpose of describing particular embodiments by way of example only and is not intended to be limiting of the claimed disclosure. Also, as used in the specification and including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment. It is also understood that all spatial references, such as, for example, horizontal, vertical, top, upper, lower, bottom, left and right, are for illustrative purposes only and can be varied within the scope of the disclosure. For example, the references “upper” and “lower” are relative and used only in the context to the other, and are not necessarily “superior” and “inferior”.

Further, as used in the specification and including the appended claims, “treating” or “treatment” of a disease or condition refers to performing a procedure that may include administering one or more drugs to a patient (human, normal or otherwise or other mammal), in an effort to alleviate signs or symptoms of the disease or condition. Alleviation can occur prior to signs or symptoms of the disease or condition appearing, as well as after their appearance. Thus, treating or treatment includes preventing or prevention of disease or undesirable condition (e.g., preventing the disease from occurring in a patient, who may be predisposed to the disease but has not yet been diagnosed as having it). In addition, treating or treatment does not require complete alleviation of signs or symptoms, does not require a cure, and specifically includes procedures that have only a marginal effect on the patient. Treatment can include inhibiting the disease, e.g., arresting its development, or relieving the disease, e.g., causing regression of the disease. For example, treatment can include reducing acute or chronic inflammation; alleviating pain and mitigating and inducing re-growth of new ligament, bone and other tissues; as an adjunct in surgery; and/or any repair procedure. Also, as used in the specification and including the appended claims, the term “tissue” includes soft tissue, ligaments, tendons, cartilage and/or bone unless specifically referred to otherwise.

The following discussion includes a description of a mixing system and related methods of employing the system in accordance with the principles of the present disclosure. Alternate embodiments are also disclosed. Reference will now be made in detail to the exemplary embodiments of the present disclosure, which are illustrated in the accompanying figures. Turning now to FIGS. 1-4, there are illustrated components of a medical system, such as, for example, a component extraction system 10 for use with bone cement in accordance with the principles of the present disclosure.

The components of system 10 can be fabricated from biologically acceptable materials suitable for medical applications, including metals, synthetic polymers, ceramics, glass and bone material and/or their composites, depending on the particular application and/or preference of a medical practitioner. For example, the components of system 10, individually or collectively, can be fabricated from materials such as stainless steel alloys, commercially pure titanium, titanium alloys, Grade 5 titanium, super-elastic titanium alloys, cobalt-chrome alloys, stainless steel alloys, superelastic metallic alloys (e.g., Nitinol, super elasto-plastic metals, such as GUM METAL® manufactured by Toyota Material Incorporated of Japan), ceramics and composites thereof such as calcium phosphate (e.g., SKELITE™ manufactured by Biologix Inc.), thermoplastics such as polyaryletherketone (PAEK) including polyetheretherketone (PEEK), polyetherketoneketone (PEKK) and polyetherketone (PEK), carbon-PEEK composites, PEEK-BaSO₄ polymeric rubbers, polyethylene terephthalate (PET), fabric, silicone, polyurethane, silicone-polyurethane copolymers, polymeric rubbers, polyolefin rubbers, hydrogels, semi-rigid and rigid materials, elastomers, rubbers, thermoplastic elastomers, thermoset elastomers, elastomeric composites, rigid polymers including polyphenylene, polyamide, polyimide, polyetherimide, polyethylene, epoxy, bone material including autograft, allograft, xenograft or transgenic cortical and/or corticocancellous bone, and tissue growth or differentiation factors, partially resorbable materials, such as, for example, composites of metals and calcium-based ceramics, composites of PEEK and calcium based ceramics, composites of PEEK with resorbable polymers, totally resorbable materials, such as, for example, calcium based ceramics such as calcium phosphate, tri-calcium phosphate (TCP), hydroxyapatite (HA)-TCP, calcium sulfate, or other resorbable polymers such as polyaetide, polyglycolide, polytyrosine carbonate, polycaroplaetohe and their combinations. Various components of system 10 may have material composites, including the above materials, to achieve various desired characteristics such as strength, rigidity, elasticity, compliance, biomechanical performance, durability and radiolucency or imaging preference. The components of system 10, individually or collectively, may also be fabricated from a heterogeneous material such as a combination of two or more of the above-described materials. The components of system 10 may be monolithically formed, integrally connected or include fastening elements and/or instruments, as described herein.

System 10 is employed, for example, with an open, mini-open or minimally invasive surgical technique to fill voids, provide patches, attach prosthetic devices, etc., or any other bone related repairs or treatments.

Referring to FIGS. 1-4, a system 10 for containing fumes for a bone cement component is shown. System 10 includes a base 12 having an inner wall 14. Wall 14 defines a chamber 16 and a sealable opening 18. Chamber 16 defines a passageway 20 through which a plunger housing 38 moves, as discussed herein. In one embodiment, inner wall 14 has a frictional surface configuration to enhance engagement with plunger housing 38. It is envisioned that surface of inner wall 14 may include alternate surface configurations, such as, for example, rough, arcuate, undulating, mesh, porous, semi-porous, dimpled and/or textured according to the requirements of a particular application. Chamber 16 includes a powder component 22 of bone cement. A membrane 24 is disposed over opening 18 to prevent powder component 22 from passing through opening 18 during the mixing process. It is contemplated that membrane 24 is a thin seal such that it can be easily punctured to release the contents of chamber 16.

System 10 includes a handle 26 that extends between a proximal end 28 and a distal end 30. Proximal end 28 may include a knob 32 configured to facilitate translation and rotation of handle 26. Distal end 30 includes a seal, such as, for example, a stopper 34. Handle 26 is moveable between a first orientation such that handle 26 is disposed within and seals opening 54 of plunger housing 38 and a second orientation such that handle 26 is disposed within and seals opening 18 of base 12. Stopper 34 is configured to seal opening 18 and opening 54 of plunger housing 38. Stopper 34 includes an outer surface 36 configured to frictionally engage openings 18, 54 to prevent leakage. It is envisioned that outer surface 36 may include alternate surface configurations, such as, for example, rough, arcuate, undulating, mesh, porous, semi-porous, dimpled and/or textured according to the requirements of a particular application.

System 10 includes a plunger housing 38 extending between a proximal end 39 and a distal end 41. Plunger housing 38 is configured for moveable disposal of handle 26. Plunger housing 38 includes an inner surface 40 and an outer surface 42. Inner surface 40 defines a cavity 44. Handle 26 is moveably disposed in cavity 44. A vial 46 is disposed within cavity 44. Cavity 44 may include elastic pieces or other structures, which are configured to pinch, squeeze or otherwise hold vial 46 therein. Vial 46 contains a fluid substance, such as, for example, a monomer component of bone cement. A vial-breaking device, such as, for example, a spike or needle 48 is disposed in cavity 44. Vial 46 is configured to be advanced towards spike 48 to break vial 46 to release the contents into the plunger housing 38. In one embodiment, the vial-breaking device may be solid and permit fluid to flow over it. In one embodiment, the vial-breaking device can be configured with channels or grooves to direct the liquid monomer into the cement powder.

A plunger portion 50 is disposed at end 41. Plunger portion 50 and plunger housing 38 are configured to engage wall 14 of base 12. Plunger portion 50 includes an outer surface 52 configured to frictionally engage wall 14. Outer surface 42 of plunger housing 38 is configured to frictionally engage wall 14. It is envisioned that outer surfaces 52, 42 may include alternate surface configurations, such as, for example, rough, arcuate, undulating, mesh, porous, semi-porous, dimpled and/or textured according to the requirements of a particular application. End 41 of plunger housing 38 includes a sealable opening 54 being in communication with chamber 16 of base 12. Opening 54 is configured such that fluid release from vial 46 is directed into base 12. Plunger housing 38 is configured for engagement with base 12 such that plunger housing 38 is configured to translate up and down within passageway 20 such that plunger housing 38 pushes the bone cement out of opening 18 into a dispensing device, as discussed herein.

System 10 includes a collapsible paddle, such as, for example a collapsible whisk 56. Whisk 56 is attached to handle 26 between ends 28, 30. Whisk 56 is configured to mix the bone cement. Whisk 56 is moveable between a collapsed position when contained within plunger housing 38 and an expanded position when contained within base 12. In the expanded position, whisk 56 mixes the bone cement.

A dispensing device, such as, for example, a syringe 58 is removeably attached with opening 18 of base 12. Syringe 58 draws a vacuum at opening 18 to draw the contents of base 12 into syringe 58 such that fumes are contained in base 12 and the dispensing device. Syringe 58 provides a sealed connection with opening.

Referring to FIGS. 1-4 a method for employing device 10 is illustratively shown in accordance with one embodiment. The method includes providing device 10 as described above. Vial 46 of a monomer component of bone cement is located in plunger housing 38 and powder component 22 of bone cement is located in base 12. Stopper 34 is initially positioned such that it seals opening 54 of plunger housing 38. Handle 26 is translated in the direction shown by arrow A in FIG. 2 through base 12 such that stopper 34 seals opening 18 in base 12. In this position, whisk 56 expands outward from handle 26. Plunger housing 38 is rotated causing vial 46 to rotate and come into contact with spike 48 to pierce vial 46. The monomer contained inside vial 46 is released from vial 46 and exits from plunger housing 38 through opening 54 into chamber 16 of base 12.

The monomer and powder 22 are mixed to form the bone cement by rotating handle 26 as shown by arrows B in FIG. 2 such that whisk 56 mixes the bone cement. Once bone cement is mixed, handle 26 is translated in the direction shown by arrow C in FIG. 3 back into plunger housing 38 to seal opening 54 thereby trapping bone cement fumes within chamber 16. As whisk 56 is moved through opening 54, whisk 56 returns to its collapsed position and opening 54 wipes remaining bone cement from whisk 56. Dispensing device 58 is attached to opening 18 or base 12 such that membrane 24 is pierced causing allowing the bone cement to pass through opening 18. To facilitate movement of the bone cement into dispensing device 58, plunger housing 38 moves in the direction shown by arrow D in FIG. 4 through passageway 20. As plunger housing 38 moves, surfaces 42, 52 of plunger housing 38 and plunger portion 50, respectively engaged wall 14 of base 12 such that a tight fit connection is maintained to push all bone cement out of chamber 16 and contain the bone cement fumes therein.

In this example, the bone cement may be formed from a powder (e.g., pre-polymerized PMMA and/or PMMA or MMA co-polymer beads and/or amorphous powder, radio-opacifer, initiator) and a liquid (e.g., MMA monomer, stabilizer, inhibitor). The two components are mixed, and a free radical polymerization occurs when the components are mixed. The bone cement viscosity changes over time from a runny liquid into a dough-like material that can be applied and then finally cures into solid hardened material. The mixture is mixed or infused by a mixing element.

In assembly, operation and use, system 10 described above, are employed in a surgical procedure, such as, for the treatment or repair of bones. For example, as shown in FIGS. 1-4, system 10 can be employed for safer mixing of bone cement components for the treatment and repair of bones, to strengthen or rebuild bones, etc. It is contemplated that one or all of the components of system 10 can be delivered or employed as a pre-assembled device or can be assembled in situ. System 10 may be completely or partially revised, removed or replaced. In one embodiment, the plunger housing 38 may be shipped having vial 46 contained therein. In other words, a packed kit may include system 10 including a vial 46 contained in a plunger housing 38 with base 12 containing powder 22 and an optional syringe 58 with a compatible fitting.

For example, as shown in FIGS. 1-4, system 10, described above, can be employed during a surgical procedure for mixing and dispensing bone cement. In use, a medical practitioner obtains access to a surgical site including a bone in any appropriate manner, such as through incision and retraction of tissues. It is envisioned that system 10 can be used in any existing surgical method or technique including open surgery, mini-open surgery, minimally invasive surgery and percutaneous surgical implantation, whereby the bone is accessed through a mini-incision, or sleeve that provides a protected passageway to the area. Once access to the surgical site is obtained, the particular surgical procedure can be performed for treating or repairing the bone.

An incision is made in the body of a patient and a cutting instrument (not shown) creates a surgical pathway for implantation of components for supplying bone cement mixed using system 10. A preparation instrument (not shown) can be employed to prepare tissue surfaces of the bone, as well as for aspiration and irrigation of a surgical region according to the requirements of a particular surgical application.

Holes, fractures, voids, depressions, etc. may exist in the bone or may be created in the bone as part of the procedure. After appropriate steps are taken for the treatment or repair, these holes, fractures, voids, depressions, etc. are filled with the mixed bone cement to maintain or improve the bone's structural integrity. Components are delivered to the surgical site along the surgical pathway(s) and into or onto bone tissue.

In one embodiment, an agent may be mixed with or delivered with bone cement (in, e.g., in the two components) or delivered separately. It is envisioned that the agent may include bone growth promoting material.

It is contemplated that the agent may include therapeutic polynucleotides or polypeptides. It is further contemplated that the agent may include biocompatible materials, such as, for example, biocompatible metals and/or rigid polymers, such as, titanium elements, metal powders of titanium or titanium compositions, sterile bone materials, such as allograft or xenograft materials, synthetic bone materials such as coral and calcium compositions, such as HA, calcium phosphate and calcium sulfite, biologically active agents, for example, gradual release compositions such as by blending in a bioresorbable polymer that releases the biologically active agent or agents in an appropriate time dependent fashion as the polymer degrades within the patient. Suitable biologically active agents include, for example, BMP, Growth and Differentiation Factors proteins (GDF) and cytokines. Components can be made of radiolucent materials such as polymers. Radiomarkers may be included for identification under x-ray, fluoroscopy, CT or other imaging techniques. It is envisioned that the agent may include one or a plurality of therapeutic agents and/or pharmacological agents for release, including sustained release, to treat, for example, pain, inflammation and degeneration.

It is envisioned that the use of microsurgical and image guided technologies may be employed to access, view and repair bone deterioration or damage. Upon completion of the procedure, the surgical instruments and assemblies are removed and the incision is closed.

In one embodiment, as shown in FIG. 5, similar to the device shown in FIGS. 1-4, a system 110 for containing fumes for a bone cement component is disclosed. System 110 includes a base 112 having an inner wall 114. Wall 114 defines a chamber 116 and a sealable opening 118. Chamber 116 defines a passageway 120 through which a plunger housing 138 moves, as discussed herein. Chamber 116 includes a powder component 122 of bone cement.

System 110 includes a plunger housing 138 extending between a proximal end 139 and a distal end 141. Plunger housing 138 includes an inner surface 140 and an outer surface 142. Inner surface 140 defines a cavity 144. A vial 146 is disposed within cavity 144. Cavity 144 may include elastic pieces or other structures, which are configured to pinch, squeeze or otherwise hold vial 146 therein. Vial 146 contains a fluid substance, such as, for example, a monomer component of bone cement. A vial-breaking device, such as, for example, a spike or needle 148 is disposed in cavity 144. Vial 146 is configured to be advanced towards spike 148 to break vial 146 to release the contents into the plunger housing 138.

A plunger portion 150 is disposed at end 141. Plunger portion 150 and plunger housing 138 are configured to engage wall 114 of base 112. Plunger portion 150 includes an outer surface 152 configured to frictionally engage wall 114. Outer surface 142 of plunger housing 138 is configured to frictionally engage wall 114. End 141 of plunger housing 150 includes a filter 154 being in communication with chamber 116 of base 112. Filter 154 is configured such that fluid release from vial 146 is passes through filter 154 and directed into base 112 while the broken remains of vial 146 remain in plunger housing 138. Plunger housing 138 is configured for engagement with base 112 such that plunger housing 138 is configured to translate up and down within passageway 120 such that plunger housing 138 pushes the bone cement out of opening 118 into a dispensing device, as discussed herein.

A cap 160 is disposed at end 139 of plunger housing 138. Cap 160 is threadably engaged with end 139 such that cap 160 and is configured for rotation about end 139. Cap 160 may include structures, such as, for example, plastic pieces 162 that are configured to pinch, squeeze or otherwise hold vial 146 therein. Rotation of cap 160 and threaded engagement of cap 160 with end 139 causes vial 146 to advance towards spike 148 to break vial 146 and release the monomer contained within vial 146.

System 10 includes a collapsible whisk 156 disposed within base 112. Whisk 156 is attached to plunger housing 138 at end 141. Whisk 156 is configured to mix the bone cement. Whisk 156 is moveable between a collapsed position and an expanded position. In the expanded position, whisk 156 mixes the bone cement. When a downward force, as shown by arrow E in FIG. 5 is applied to cap 160, plunger housing 138 is incrementally rotated to rotate whisk 156 such that it mixes the bone cement.

A dispensing device, such as, for example, a syringe 158 is removeably attached with opening 118 of base 112. Syringe 158 draws a vacuum at opening 118 to draw the contents of base 112 into syringe 158 such that fumes are contained in base 112 and the dispensing device. Syringe 158 provides a sealed connection with opening 118.

It will be understood that various modifications may be made to the embodiments disclosed herein. Therefore, the above description should not be construed as limiting, but merely as exemplification of the various embodiments. Those skilled in the art will envision other modifications within the scope and spirit of the claims appended hereto.

What is claimed is:

1. A device for mixing and containing fumes for a bone cement component comprising:
a base including an inner wall defining a chamber having a first sealable opening and a passageway;
a handle extending between a proximal end and a distal end and including a seal at the distal end;
a plunger housing configured for moveable disposal of the handle and includes a plunger portion and a second sealable opening, the plunger housing configured to contain a vial therein, the plunger housing configured for engagement with the base, wherein the plunger housing is configured to move within the passageway;
a collapsible paddle attached to the handle between the proximal and distal end and configured to mix the bone cement,
wherein the handle is moveable between a first orientation such that the handle is disposed within and seals the opening of the plunger housing and a second orientation such that the handle is disposed within and seals the opening of the base.

2. A device as recited in claim 1, wherein the sealable opening of the base in communication with a dispensing device.

3. A device as recited in claim 1, wherein the paddle is configured to be moveable between a first collapsed position and a second expanded position such that the paddle is utilized to mix the bone cement.

4. A device as recited in claim 1, wherein the paddle is a whisk.

5. A device as recited in claim 1, wherein the plunger housing is configured for translation through the passageway such that the plunger housing pushes the bone cement out of the sealable opening in the base to dispense the bone cement.

6. A device as recited in claim 1, wherein the plunger housing includes a vial-breaking device and the plunger housing is configured for rotation such that the vial-breaking device pierces the vial to release a substance.

7. A device as recited in claim 6, wherein the vial-breaking device includes a spike or needle.

8. A device as recited in claim 1, wherein the vial includes a monomer component for bone cement.

9. A device as recited in claim 1, wherein the plunger housing includes a vial-breaking device and the plunger housing includes a cap configured for rotation about the plunger housing such that rotation of the cap causes the vial-breaking device to pierce the vial.

10. A device as recited in claim 9, wherein the cap is threadably engaged with the plunger housing.

11. A device as recited in claim 1, wherein the plunger housing includes a filter disposed at the sealable opening of the plunger housing.

12. A device as received in claim 9, wherein the cap is configured to incrementally rotate the paddle to mix the bone cement within the base.

13. A device as recited in claim 1, wherein the base is configured as a mixing chamber such that fumes are contained in the base and the dispensing device.

14. A device as recited in claim 1, wherein the system is disposable.

15. A system for mixing and containing fumes for a bone cement component comprising:
a base including an inner wall defining a chamber having a first sealable opening and a passageway;
a handle extending between a proximal end and a distal end and including a seal at the distal end;
a plunger housing configured for moveable disposal of the handle and includes a plunger portion and a second sealable opening, the plunger housing configured to contain a vial therein, the plunger housing configured for engagement with the base, wherein the plunger housing is configured to move within the passageway;
a collapsible whisk attached to the handle between the proximal and distal end and configured to mix the bone cement; and
a dispensing device removeably attached to and in communication with the sealable opening of the base,
wherein the handle is moveable between a first orientation such that the handle is disposed within and seals the opening of the plunger housing and a second orientation such that the handle is disposed within and seals the opening of the base.

16. A system as recited in claim 15, wherein the plunger housing includes a vial-breaking device and the plunger housing configured for rotation such that the vial-breaking device pierces the vial to release a substance.

17. A system as recited in claim 15, wherein the plunger housing is configured for translation through the passageway such that the plunger housing pushes the bone cement out of the sealable opening in the base to dispense the bone cement.

18. A method for containing fumes of a bone cement component, the method comprising the steps of:
providing a system for mixing and dispensing bone cement including a base including an inner wall defining a chamber having a first sealable opening and a passageway; a handle extending between a proximal end and a distal end and including a stopper at the distal end; a plunger housing configured for moveable disposal of the handle and includes a plunger portion and a second sealable opening, the plunger housing configured to contain a vial therein, the plunger housing configured for engagement with the base, wherein the plunger housing is configured to move within the passageway; and a syringe is removeably attached to and in communication with the base;
providing a vial of a monomer component of bone cement in the plunger housing and a powder component of bone cement in the base;
positioning the stopper at the sealable opening of the plunger housing;
translating the handle through the base such that the stopper seals the sealable opening in the base and the whisk expands;
rotating the plunger housing to break the vial against a spike to break the vial and release the monomer from the vial;
rotating the handle such that the whisk mixes the monomer and the powder;
moving the handle back into the plunger housing; and
attaching the dispensing syringe to the base and translating the plunger housing through the passageway into the base to dispense the bone cement into the dispensing device.

19. A method for containing fumes of a bone cement component as recited in claim 18, wherein as the whisk is moved back into the plunger housing, the opening of the plunger housing wipes the bone cement off the whisk.

20. A method for containing fumes of a bone cement component as recited in claim 18, wherein the monomer component is liquid and drips into the powder component of the bone cement to form the bone cement.
